(19) United States
(12) Patent Application Publication
(10) Pub. No.: US 2009/0037839 A1
(43) Pub. Date: Feb. 5, 2009

(54) DISPLAY CONTROL DEVICE AND IMAGE FORMING APPARATUS

(75) Inventor: Dai Shigenobu, Osaka (JP)

Correspondence Address: CONNOLLY BOVE LODGE & HUTZ LLP, 1875 EYE STREET, N.W., SUITE 1100, WASHINGTON, DC, 20006, US

(73) Assignee: KYOCERA MITA Corporation, Osaka (JP)

(21) Appl. No.: 12/134,706

(22) Filed: Jun. 6, 2008

(30) Foreign Application Priority Data
Jul. 31, 2007 (JP) 2007-199765

(51) Int. Cl. G06F 3/048

(52) U.S. Cl. 715/781

(57) ABSTRACT

In a display control device according to the embodiments of the invention a display control part displays, if a screen switch instruction to switch to an operational condition input screen is accepted by a display screen switch key when any screen from a first guidance screen B to an n-th guidance screen D is displayed in a display part, an operational condition input screen E indicated by the screen switch instruction in the display part, as well as the screen from the first guidance screen B to the n-th guidance screen D that has been displayed in the display part in a reduced size in a portion of a display area of the operational condition input screen E.

### BACKGROUND OF THE INVENTION

1. Field of the Invention

The embodiments of the invention relates to display control devices and image forming apparatuses, and in particular, to display control of a display part.

2. Description of the Related Art

Conventionally, a typical image forming apparatus such as a photocopier and a multifunction product (MFP) including a copy function, a facsimile function, and a print function, can perform a multifunctional operation, and in order to show a user how to operate to perform each of available functions, operation guidance screens for the available functions that meets the user's needs are displayed on a display part such as a liquid crystal display (LCD) by sequentially switching. With such an image forming apparatus, in order for the user to have the image forming apparatus perform a desired operation, the user is required to learn how to operate to perform the desired operation after going through various display screens of the display part. For this reason, an apparatus has been proposed a display input operation device that facilitates switching of one display screen to a new display screen (see Japanese Patent No. 3761306).

However, while such a conventional image forming apparatus can facilitate the switching of a display screen to a new screen, what has been displayed in the previous display screen is not present to the user after switching the display screen to a different display screen. Accordingly, with the conventional image forming apparatus, when the user wishes to check the content of the previous display screen, the user is disadvantageously required to switch the display part to display the previous display screen.

### SUMMARY OF THE INVENTION

The embodiments of the invention are contrived in order to address the above noted problem. An object of the embodiments of the invention is to allow a user to check a content of one display screen even after switching the one display screen of a display part to another display screen.

A display control device according to one embodiment of the invention includes a display part that displays a plurality of display screens; a display image data storage part that stores image data for each display screen that is displayed in the display part, the display screen including an operation guidance screen with which an operation guidance is displayed for a user and an operational condition input screen with which an input instruction for an operational condition from the user is accepted; a screen switch instruction accepting part that accepts a screen switch instruction from the user, the screen switch instruction being an instruction to switch the display screen displayed in the display part; and a display control part that reads the image data for each display screen that is stored in the display image data storage part and displays each display screen in the display part, wherein when a screen switch instruction to switch to the operational condition input screen is accepted by the switch instruction accepting part when the operation guidance screen is displayed in the display part, the display control part reads the image data for the operational condition input screen indicated by the screen switch instruction from the display image data storage part, and displays the operational condition input screen in the display part, as well as the operation guidance screen that has been displayed in the display part in a reduced size in a portion of a display area of the operational condition input screen.

With the display control device according to the embodiments of the invention, even after switching the display screen from the operation guidance screen to the operational condition input screen, the user can check the content that has been displayed in the operation guidance screen before switching by viewing the operational condition input screen after switching.

Another embodiment of the invention is a method for controlling the display control device, comprising: selecting one of a plurality of guidance selection keys; displaying a guidance selection screen selected by the guidance selection key; selecting an operating function from the one of a plurality of guidance selection keys on the guidance selection screen; displaying at least one of a plurality of guiding screens in accordance with the selected operating function; switching to one of the plurality of guiding screens when at least one of a next page, previous page and screen switch keys is selected; displaying the next page when the next page key is selected and returning to the switching step; displaying the previous page when the previous page key is selected and returning to the switching step; displaying an operational condition input screen when the switch key is activated, wherein displaying the operational input screen further comprises: displaying a guidance screen associated with the operational condition; storing the operational condition when the operational condition is inputted; returning to displaying the operation condition input screen when the switch key is not selected; displaying at least one of the plurality of guiding screens previously displayed before switching to the operational condition input screen and returning to the switching step when the switch key is selected ; returning to the switching step when at least one of a guidance key and reset key is not selected and when at least one of a next page, previous page and screen switch keys is not selected; and displaying a previous guiding screen and then switching to a present guiding screen.

Yet another embodiment of the invention is a processor-readable storage medium containing a software program operable to cause a display control device including a processor operating under the instructions of the software program to perform a method for controlling the display control device, comprising: selecting one of a plurality of guidance selection keys; displaying a guidance selection screen selected by the guidance selection key; selecting an operating function from the one of a plurality of guidance selection keys on the guidance selection screen; displaying at least one of a plurality of guiding screens in accordance with the selected operating function; switching to one of the plurality of guiding screens when at least one of a next page, previous page and screen switch keys is selected; displaying the next page when the next page key is selected and returning to the switching step; displaying the previous page when the previous page key is selected and returning to the switching step; displaying an operational condition input screen when the switch key is activated, wherein displaying the operational input screen further comprises: displaying a guidance screen associated with the operational condition; storing the operational condition when the operational condition is inputted; returning to displaying the operation condition input screen when the switch key is not selected; displaying at least one of the plurality of guiding screens previously displayed before switching to the operational condition input screen and returning to the switching step when the switch key is selected ; returning to the switching step when at least one of a guidance key and reset key is not selected and when at least one of a next page, previous page and screen switch keys is not selected; and displaying a previous guiding screen and then switching to a present guiding screen.

These and other objects, features, aspects, and advantages of the embodiments of the invention will become more apparent by reading the following detailed description with reference to the appended.

### BRIEF DESCRIPTION OF THE DRAWINGS

FIG. 1 is a schematic side view illustrating a configuration of an MFP as an example of an image forming apparatus according to one embodiment of the embodiments of the invention;

FIG. 2 is a control block diagram of the MFP illustrated in FIG. 1;

FIG. 3 is a flowchart showing a process when a display screen is displayed in a display part;

FIG. 4 is a diagram illustrating an example of a guidance selection screen;

FIG. 5 is a diagram illustrating a shift between display screens at the display part; and

FIG. 6 is a diagram illustrating an example of an operational condition input screen.

### DETAILED DESCRIPTION OF THE PREFERRED EMBODIMENTS

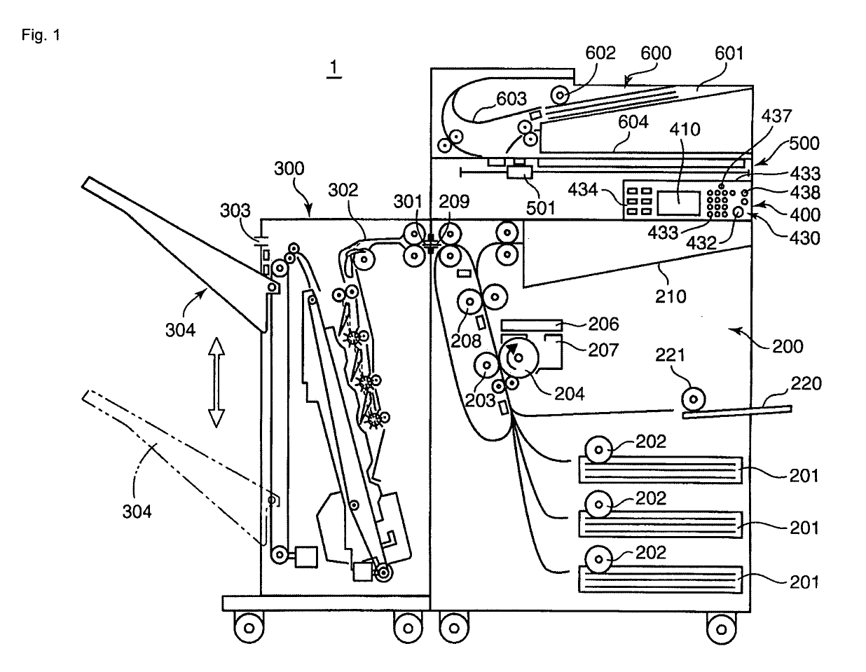

The following describes a display control device according to the embodiments of the invention as well as an image forming apparatus provided with such a display control device. FIG. 1 is a schematic side view illustrating a configuration of a multifunction product (MFP) as an example of an image forming apparatus according to one embodiment of the invention. An MFP 1 includes a main body part 200, a sheet post processing part 300 that is provided on a side to which a sheet is carried out, e.g. a left hand, of the main body part 200, an operation part 400 with which a user inputs various operation commands and such, a document read part 500 provided above the main body part 200, and a document feed part 600 provided above the document read part 500.

The operation part 400 is provided with a display part 410 constituted by a liquid crystal display (LCD) and such, and an operation key part 430 into which the user inputs an operation instruction. The operation key part 430 includes a start key 432, a numeric keypad 433, a function switch key 434, a guidance key 437, and such. The guidance key 437 accepts an input from the user that instructs to switch the display in a display screen of the display part 410 to a guiding screen explaining to the user how to operate the device. A reset key 438 accepts an input from the user that instructs to reset an operational condition that has been inputted by the user so that the display in the display screen of the display part 410 is returned to an initial screen.

The start key 432 accepts an input from the user that instructs to start an operation such as a copy operation or a scan operation. The numeric keypad 433 accepts an input from the user that instructs to specify a number of copies. The function switch key 434 accepts an input from the user that instructs to switch between functions such as a copy function, transmission function (scanner function, facsimile function, and such), and a box function (a function to read and print out data stored in a memory area (mail box) for each user provided within an HDD 74 that will be described later).

The display part 410 is constituted by such as an LCD, and provided with a touch panel unit into which a touch panel is assembled. The display part 410 is capable of displaying various operation screens, and of allowing the user to input an instruction to perform various functions by touching a display surface (an operation key that is displayed).

The document feed part 600 is provided with a document set part 601, a feed roller 602, a document carry part 603, and a document discharge part 604, and the document read part 500 is provided with a scanner 501. The feed roller 602 feeds a predetermined pieces of a document one by one that is set on the document set part 601, and the document carry part 603 sequentially carries the pieces of the document that are being fed to a reading position of the scanner 501. The scanner 501 sequentially reads images of the pieces of the document that are being carried, and the read pieces of the document are discharged to the document discharge part 604.

The main body part 200 is provided with a plurality of paper cassettes 201, a plurality of feed rollers 202, a transfer roller 203, a photoreceptor drum 204, an exposure device 206, a development device 207, a fuser roller 208, a discharge outlet 209, a catch tray 210, and such.

The photoreceptor drum 204 is evenly charged by a charging device (not depicted) as the photoreceptor drum 204 rotates in a direction indicated by an arrow. The exposure device 206 forms electrostatic latent images of individual colors on a surface of the photoreceptor drum 204 by scanning the photoreceptor drum 204 by a laser beam modulated according to the image of the document that has been read by the document read part 500. The development device 207 forms a toner image by supplying the photoreceptor drum 204 with a black developer.

On the other hand, the feed rollers 202 pull a printing sheet from one of the paper cassettes 201 each containing printing sheets, and feed the printing sheet to the transfer roller 203. The transfer roller 203 transfers the toner image from the photoreceptor drum 204 onto the printing sheet that has been carried, and the fuser roller 208 heats and fuses the transferred toner image to the printing sheet. Then, printing sheet is carried from the discharge outlet 209 of the main body part 200 to the sheet post processing part 300. Further, printing sheet is also discharged to the catch tray 210 as needed.

The sheet post processing part 300 is provided with a carry-in inlet 301, a printing sheet carrying part 302, a carryout outlet 303, a stack tray 304, and such. The printing sheet carrying part 302 sequentially carries printing sheets that have been carried to the carry-in inlet 301 from the discharge outlet 209, and finally discharges the printing sheets from the carryout outlet 303 to the stack tray 304. The stack tray 304 is configured to be movable up and down in a direction indicated by an arrow according to a number of a stack of the printing sheets that have been carried out from the carryout outlet 303.

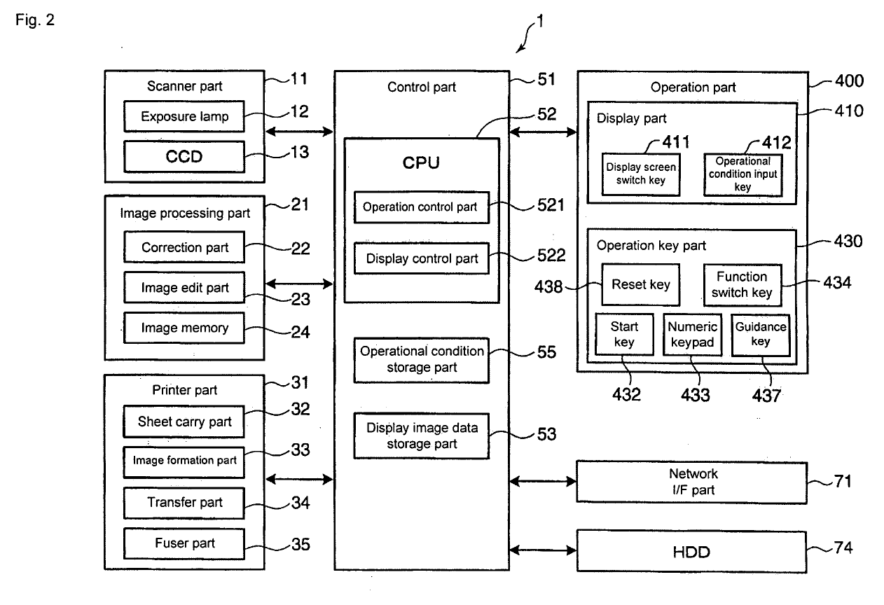

FIG. 2 is a control block diagram of the MFP 1 shown in FIG. 1. The MFP 1 is provided with a scanner part 11, an image processing part 21, a printer part 31, the operation part 400, a control part 51, a network interface (I/F) part 71, and the hard disk drive (HDD) 74.

The scanner part 11 includes an exposure lamp 12 and a charge-coupled device (CCD) 13 that constitute the scanner 501 as shown in FIG. 1. The scanner part 11 reads an image of the document by irradiating the document with the exposure lamp 12 and having the CCD 13 receive the light reflected on the document Then, the scanner part 11 outputs an image corresponding to the read image to the image processing part 21.

The image processing part 21 includes a correction part 22, an image edit part 23, and an image memory 24. The image processing part 21 processes the read image as needed using the correction part 22 and the image edit part 23, stores the processed image in the image memory 24, and outputs the processed image to the printer part 31. The correction part 22 performs a predetermined correction such as level correction and gamma correction to the read image. The image edit part 23 edits the image in various ways such as compression or extension and/or enlargement or reduction of the image.

The printer part 31 includes a sheet carry part 32 having such as the paper cassettes 201 and the feed rollers 202 as shown in FIG. 1, an image formation part 33 having such as the photoreceptor drum 204, the exposure device 206, and the development device 207 as shown in FIG. 1, a transfer part 34 having such as the transfer roller 203 as shown in FIG. 1, and a fuser part 35 having such as the fuser roller 208 as shown in FIG. 1. The printer part 31 prints an image onto a recording sheet using document data read by the scanner part 11. 11 Specifically, the sheet carry part 32 carries a recording sheet to the image formation part 33, the image formation part 33 forms a toner image that corresponds to the image to be printed, the transfer part 34 transfers the toner image onto the recording sheet, and the fuser part 35 fuses the toner image on the recording sheet, thereby forming the image.

The network I/F part 71 controls transmission of various data between external devices through LAN using a network interface (10/100Base-TX) or such. The HDD 74 stores an image read by the scanner part 11, an output format that is set for the image, and such.

As shown in FIG. 1, the operation part 400 is provided with the display part 410 and the operation key part 430. In the display part 410, a plurality of keys capable of accepting various different instructions by a touch panel function are displayed. For example, a display screen switch key 411 and an operational condition input keys 412 are displayed in the display part 410.

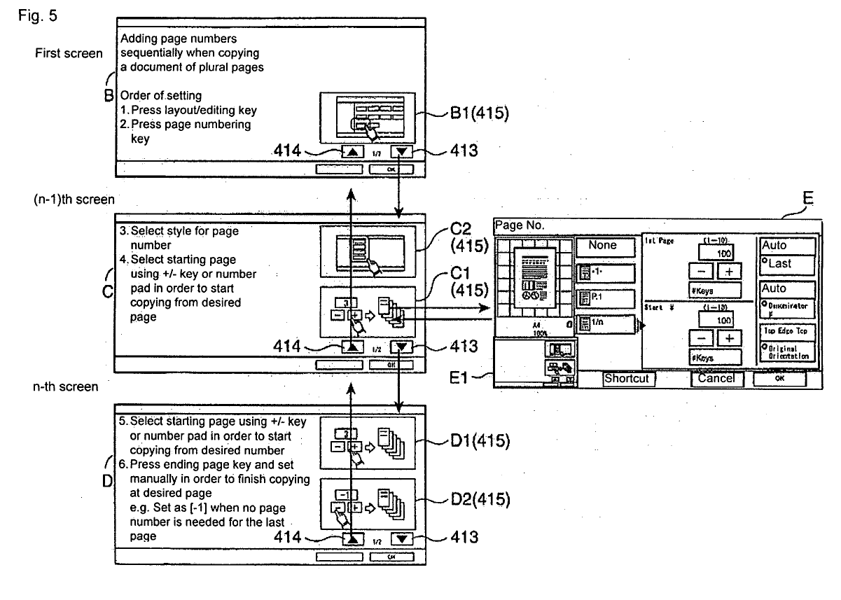

The display screen switch key 411 is displayed in the screen of the display part 410. When the user touches the display screen switch key 411, an input of an instruction to switch the display to a display screen represented by an image that has been touched become accepted. As the display screen switch keys 411, a next page key 413, a previous page key 414, and an operational condition input screen switch key 415 that will be described later with reference to FIG. 5 are provided.

The operational condition input keys 412 are displayed in an operational condition input screen when a display control part 522 switches the display screen of the display part 410 to the operational condition input screen. The operational condition input keys 412 are various keys displayed in the operational condition input screen in order to accept an input of an operational condition from the user, including a key to input a page number to add a page number, a key to set a printing color density, a key to set a printing magnification, a key to set a size of a printing sheet, and such.

The operation key part 430 is provided with the function switch key 434, the start key 432, the numeric keypad 433, the guidance key 437, the reset key 438, and such, as shown in FIG. 1. In this embodiment, the function switch key 434, the start key 432, the numeric keypad 433, the guidance key 437, the reset key 438, and such are exemplified by mechanically configured keys instead of keys using a touch sensor (these keys are not intended to be limited to mechanically configured keys).

A CPU 52 of the control part 51 accepts an instruction inputted by the user via each key of the display part 410 and the operation part 400.

The control part 51 is provided with the CPU 52, a display image data storage part 53, and an operational condition storage part 55. The CPU 52 controls the operation of the MFP 1. The display image data storage part 53 stores data such as display image data necessary to display various display screens including an operation guidance screen and the operational condition input screen. The operation guidance screen displays an operation guidance to the user. The operational condition input screen accepts an instruction for an operational condition inputted by the user.

The operational condition storage part 55 stores the various operational conditions for the MFP 1 (a value of the inputted page number, the printing color density, the setting for the printing magnification, the setting for the size of the printing sheet, and such) that have been inputted by the user by operating the operation part 400. Based on the operational conditions stored in the operational condition storage part 55, an operation control part 521 has the scanner part 11 perform a document reading operation, has the printer part 31 perform an image forming operation (printing operation), and such.

The CPU 52 is provided with the operation control part 521 and the display control part 522. The operation control part 521 controls an operation of each part of the MFP 1 (such as the scanner part 11, the image processing part 21, and the printer part 31).

The display control part 522 controls a display operation of the display part 410. The display control part 522 reads necessary image data from the display image data storage part 53 to display the operation guidance screen and the operational condition input screen, and displays the screen on the display part 410. Further, when the display screen switch key 411 accepts a display screen switch instruction by the user operating the display screen switch key 411, the display control part 522 switches the display screen of the display part 410 to a display screen indicated by the display screen switch instruction. Moreover, the display control part 522, when having the display part 410 display the operational condition input screen, displays the operation guidance screen that has been displayed in the display part 410 in a portion of a display area of the operational condition input screen in a reduced size.

A display apparatus according to one embodiment of the invention is configured by necessary parts of the operation part 400 and the control part 51.

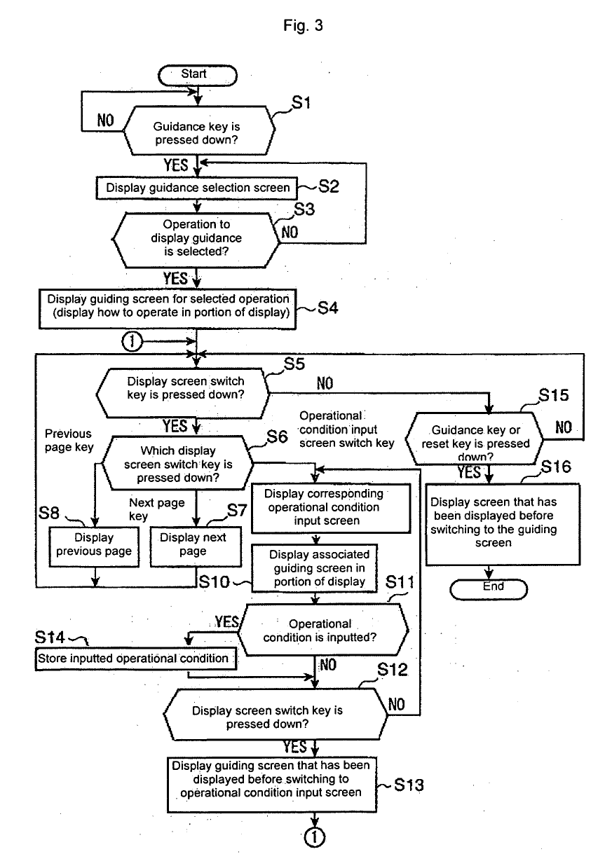

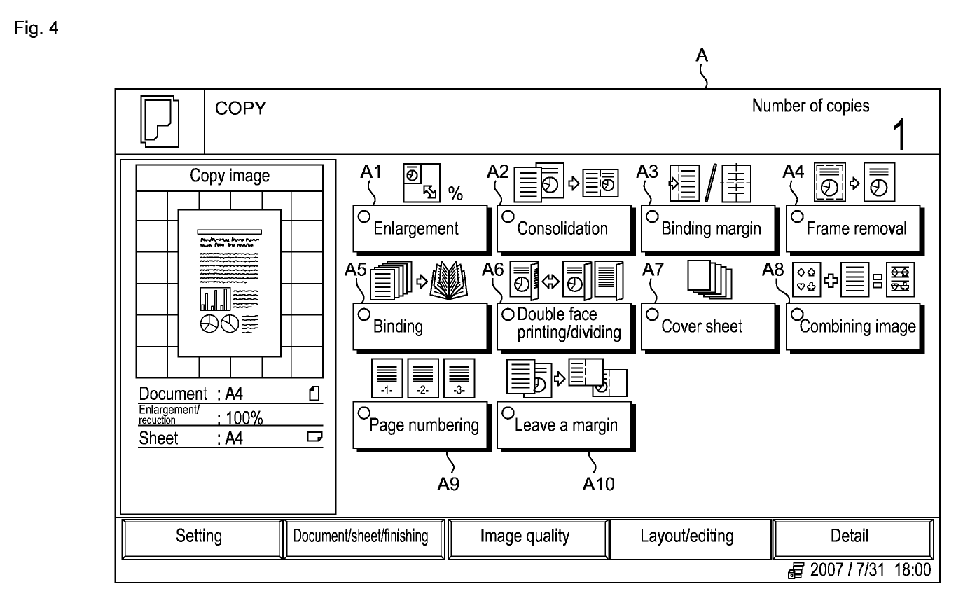

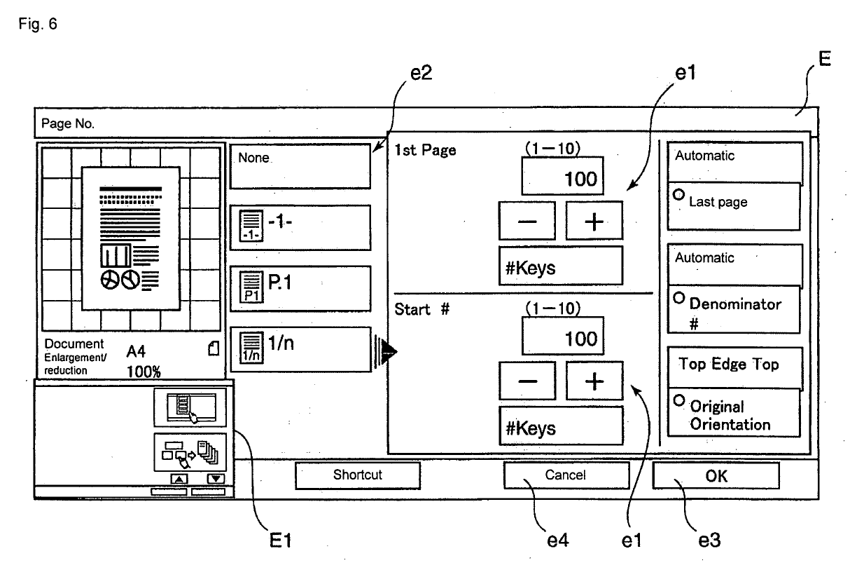

Next, an explanation is given about how the MFP 1 handles a process when a display screen is displayed in the display part 410. FIG. 3 is a flowchart showing a process when a display screen is displayed in the display part 410. FIG. 4 is a diagram illustrating an example of the guidance selection screen. FIG. 5 is a diagram illustrating a shift between display screens at the display part 410. FIG. 6 is a diagram illustrating an example of the operational condition input screen.

When the display control part 522 displays, for example, an initial screen (not shown) in the display part 410 that is displayed immediately after a main electrical switch of the MFP 1 is turned on, if the user presses down the guidance key 437 of the operation part 400, and an instruction to display the guidance selection screen (operation guidance screen) in the display part 410 is accepted by the guidance key 437 (YES in S1), the display control part 522 reads display image data of the guidance selection screen from the display image data storage part 53, and displays a guidance selection screen A, for example, as shown in FIG. 4 in the display part 410 (S2).

Guidance selection keys A1 to A10 are displayed in the guidance selection screen A. The guidance selection keys A1 to A10 are respectively associated with various functions that can be operable with the MFP 1. When any of these guidance selection keys A1 to A10 is pressed down by the user (YES in S3), the guidance selection key that has been pressed down accepts an instruction from the user to display a guiding screen (operation guidance screen), which shows how to perform the operation associated with the guidance selection key, in the display part 410.

The display control part 522 reads display image data of the guiding screen associated with the operation selected by the user by the pressing down of the guidance selection key from the display image data storage part 53, and displays the guiding screen in the display part 410 (S4). More than one guiding screens are provided so as to each correspond to a function and operation of that is available for the MFP 1, and each guiding screen is constituted by a plurality of screens from a first guidance screen to an n-th guidance screen. For example, when the user presses down the guidance selection keys A9 for “adding page number” as shown in FIG. 4, the guidance selection keys A9 accepts an instruction to display a guiding screen that corresponds to an operation of “adding page number”. When the instruction to display the guiding screen is accepted, the display control part 522 initially displays the first screen in the display part 410 among the plurality of screens (from the first guidance screen to the n-th guidance screen) that constitute the guiding screen. Then, according to a display screen switch instruction from the user, the display control part 522 displays an appropriate screen in the display part 410 by sequentially switching through the first guidance screen to the n-th guidance screen.

As shown in FIG. 5, display image data of the first guidance screen B. . . . the (n-1)th guidance screen C, and the n-th guidance screen D is such that a method of operation (how to operate via buttons in the display screen corresponding to the operation) that is guided in the corresponding screen is plainly shown by means of illustration and diagrams in a portion of a display area of each display screen. Accordingly, when the display control part 522 displays screens from the first guidance screen B to the n-th guidance screen D in the display part 410, the method of operation is guided in the corresponding screen in portions B1 and C2 of each screen that is displayed in the display part 410. Further, the next page key 413 and the previous page key 414 are displayed in the screens that constitute the guiding screen as the display screen switch keys 411.

Moreover, how to input the operational condition is displayed plainly by means of illustration and diagrams in the portion of a screen that displays a method of inputting an operational condition (for example, how to input a specific numeric value) among the first guidance screen B to the n-th guidance screen D that constitute the guiding screen. For example, as shown in FIG. 5, input guidance display areas C1, D1, and D2 that are portions in which how to input the operational condition is displayed are displayed in the (n-1)th guidance screen C and the n-th guidance screen D. When the user touches the input guidance display area C1, D1, or D2, the input guidance display area C1, D1, or D2 serves as the display screen switch key 411 by means of a touch panel function, and accepts a screen switch instruction to switch the display screen to the operational condition input screen in which the operational condition can be inputted as guided in the input guidance display area C1, D1, or D2. The (n-1)th guidance screen C illustrates an example that also shows a portion C2 in which a method of operation different from the method of inputting the operational condition (how to input a specific numeric value).

For example, when displaying the first guidance screen B and such, if any of the next page key 413, the previous page key 414, or the operational condition input screen switch key 415 is pressed down by the user (YES in S5), the display control part 522 switches the display screen in the display part 410 according to the pressed key (S6 to S9).

When the user pressed down the previous page key 414, if an instruction to display a previous screen of the screen displayed in the display part 410 at this time is accepted by the previous page key 414 (“previous page key” in S6), the display control part 522 displays the previous screen in the display part 410 (S8). For example, the display control part 522 displays the (n-1)th guidance screen C in the display part 410, if the user pressed down the previous page key 414 when the n-th guidance screen D is displayed in the display part 410. Further, the display control part 522 displays the guidance selection screen A in the display part 410, if the user pressed down the previous page key 414 when the first guidance screen B is displayed in the display part 410 (in this case, the process returns to S2).

Furthermore, when the user pressed down the next page key 413, if an instruction to display a next screen of the screen displayed in the display part 410 at this time is accepted by the next page key 413 (“next page key” in S6), the display control part 522 displays the next screen in the display part 410 (S7). For example, the display control part 522 displays the n-th guidance screen D in the display part 410 if the user pressed down the next page key 413 when the (n-1)th guidance screen C is displayed in the display part 410.

Further, if the user touches such as the input guidance display area C1 when a screen containing the input guidance display area is displayed in the display part 410 (that is, when such as the input guidance display area C1 serves as the operational condition input screen switch key 415, and the operational condition input screen switch key 415 is pressed down by the user), the operational condition input screen switch key 415 accepts the display screen switch instruction to switch to the operational condition input screen in which an input of an operational condition for the operation guided in the input guidance display area displayed in the display part 410 at this moment is allowed. As described above, when the display screen switch instruction to switch to the operational condition input screen is accepted by the operational condition input screen switch key 415 (“operational condition input screen switch key” in S6), the display control part 522 displays the operational condition input screen in which an input of the operational condition for the operation that is guided in the input guidance display area in the display part 410 (S9).

Specifically, the operational condition input screen switch key 415 accepts the display screen switch instruction for the operational condition input screen in which the input of the operational condition is allowed for the operation associated with the input guidance display area that is displayed (the input guidance display area that is pressed down by the user when more than one input guidance display areas are displayed) in the display part 410 at the time when the user touches the input guidance display area. In other words, when the user presses down the operational condition input screen switch key 415, the display control part 522 switches the display screen of the display part 410 to the operational condition input screen associated with the operational condition input screen switch key 415, and consequently the display control part 522 can display different operational condition input screens depending on the progress of the guidance from the first guidance screen B to the n-th guidance screen D. With this, the user can easily switch the display screen of the display part 410 to the operational condition input screen in which an input of the operational condition that is currently displayed is allowed by pressing down the displayed part when the method of inputting the operational condition (such as how to input a specific numeric value) is shown in the display screen of the display part 410.

Further, when the operational condition input screen is displayed in the display part 410, the display control part 522 displays a screen that has been previously displayed in the display part 410 (any screen from the first guidance screen B to the n-th guidance screen D, prior to the switching and associated with the operational condition input screen) in a reduced size in the portion in which the operational condition input screen is displayed (S10).

For example, as shown in FIG. 5, when the (n-1)th guidance screen C is displayed in the display part 410 (FIG. 1 and FIG. 2), if the user touches the input guidance display area C1 of the (n-1)th guidance screen C, the display control part 522 displays an operational condition input screen E (which is associated with the input guidance display area C1) as shown in FIG. 5 and FIG. 6 in the display part 410, and the (n-1)th guidance screen C in a reduced size in a portion E1.

After switching to the operational condition input screen E, when the operational condition is inputted by the user operating keys such as a value input key e1 and a page number type selection key e2 displayed in a display area in the operational condition input screen E (YES in S11), the operational condition storage part 55 stores the inputted operational condition (S14).

Moreover, while the operational condition input screen E is displayed, when the user pressed down the display screen switch key 411 (an OK button e3 or a cancel button e4) and a screen switch instruction to switch the display screen to the original guiding screen is accepted by the display screen switch key 411 from the user, the display control part 522 displays the original guiding screen in the display part 410 that is displayed immediately before the operational condition input screen E is displayed in the display part 410, that is, any screen from the first guidance screen B to the n-th guidance screen D (YES in S12, S13).

For example, when the user presses down the OK button e3 after inputting operational condition such as a page number, and a style and a display form for the page number via such as the value input key e1 and the page number type selection key e2 in the operational condition input screen E, such as the numerical value of the page number, and the style and the display form inputted by the user are stored in the operational condition storage part 55, and the display control part 522 switches the display screen of the display part 410 to the (n-1) th guidance screen C containing the input guidance display area C1 associated with the operational condition input screen E. In this case, the OK button e3 serves as the display screen switch key 411.

Further, when the cancel button e4 in the operational condition input screen E is pressed down by the user, the operational condition storage part 55 does not store the operational conditions such as the page number and other displays forms inputted by the user operating the value input key e1 and the page number type selection key e2. Instead, the display control part 522 switches the display screen of the display part 410 to the (n-1)th guidance screen C containing the input guidance display area C1 associated with the operational condition input screen E. In this case, the cancel button e4 serves as the display screen switch key 411.

Moreover, when the guidance key 437 or the reset key 438 is pressed down by the user while any screen from the first guidance screen B to the n-th guidance screen D is displayed in the display part 410, the guidance key 437 or the reset key 438 under this situation accepts a screen switch instruction to switch the display screen of the display part 410 to the display screen that has been displayed in the display part 410 before switching to the guiding screen (YES in S15). In addition, the display control part 522 displays the display screen that has been displayed in the display part 410 before the switching, that is, the initial screen in this embodiment, in the display part 410 (S16).

The embodiments of invention are not limited to the configuration of the embodiment as described above, and various modifications are allowed. For example, in the embodiment, when the user touches the input guidance display area in the process of S6 shown in FIG. 3, the display screen switch instruction to switch the screen to the operational condition input screen in which the operational condition for the operation associated with the input guidance display area can be accepted, and the input guidance display area serves as the operational condition input screen switch key 415 by means of the touch panel function. However, the operational condition input screen switch key 415 can be provided independently from the input guidance display area. In this case, however, at the time when the operational condition input screen switch key 415 that is provided independently is pressed by the user, the display control part 522 switches the display screen of the display part 410 to the operational condition input screen associated with the input guidance display area displayed in the display part 410.

The configuration and the process according to the embodiment shown from FIG. 1 through FIG. 6 is a mere example of the configuration and the process of the display control device and the image forming apparatus according to the embodiments of the invention, and does not intend to limit the configuration and the process of the display control device and the image forming apparatus according to the embodiments of the invention in any way. It should be understood that a number of modifications that are not illustrated can be conceived without departing the scope of the embodiments of the invention.

Moreover, the above embodiment explains an example in which the image forming apparatus according to the embodiments of the invention serves as the MFP 1. However, the image forming apparatus according to the embodiments of the invention are not limited to the MFP, and can be a photocopier, a facsimile machine, a printer, and the like.

As described above, according to the display control device of the embodiments of the invention, when a display control part displays an operation guidance screen in a display part, if a screen switch instruction to switch to the operational condition input screen is accepted by a switch instruction accepting part, the operational condition input screen indicated by the screen switch instruction is displayed in the display part, and the operation guidance screen that has been displayed in the display part is displayed in a reduced size in a portion of the operational condition input screen. Therefore, even after the display screen is switched from the operation guidance screen to the operational condition input screen, the user can see content of the operation guidance screen before the switching in the operational condition input screen after the switching.

Further, according to the display control device of the embodiments of the invention, the switch instruction accepting part accepts only the screen switch instruction to switch to the operational condition input screen in which an input of the operational condition guided in the input guidance display area in the operation guidance screen currently displayed in the display part is allowed, and the display control part switches the display screen of the display part only to the operational condition input screen. Therefore, it is ensured that the user can switch the display screen with a simple operation to the operational condition input screen in which an operational condition guided by the input guidance display area that is currently displayed is allowed.

Further, according to the display control device of the embodiments of the invention, when the user touches the input guidance display area that is being displayed, the display control part switches the display screen to the operational condition input screen in which an input of the operational condition guided in the input guidance display area is allowed. Therefore, the user can switch the display screen with a simpler operation to the operational condition input screen in which an operational condition guided by the input guidance display area that is currently displayed is allowed.

Further, according to the display control device of the embodiments of the invention, when the user pressed down a press-down part provided independently from the input guidance display area that is being displayed, the display control part switches the display screen to the operational condition input screen in which an input of the operational condition guided in the input guidance display area is allowed. Therefore, the user can switch the display screen with a simpler operation to the operational condition input screen in which an operational condition guided by the input guidance display area that is currently displayed is allowed.

Further, according to the display control device of the embodiments of the invention, the operational condition that has been inputted in the operational condition input screen is already held by the operational condition storage part even if the user switches the display screen to the operation guidance screen after inputting the operational condition in the operational condition input screen switched from the operation guidance screen. Accordingly, the user can input the operational condition while checking the necessary operation guidance by switching the display screen between the operation guidance screen and the operational condition input screen. In addition, the user can check the operation guidance screen, with a simple operation, by switching from the operational condition input screen in which the user inputs the operational condition to the operation guidance screen associated with the operational condition input screen.

It will, of course, be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive. For example, a display may be employed to display one or more queries, such as those that may be interrelated, and or one or more tree expressions, although, again, claimed subject matter is not limited in scope to this example. Likewise, an embodiment may be implement as a system, or as any combination of components such as computer systems, mobile and/or other types of communication systems and other well known electronic systems.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

What is claimed is:

1. A display control device, comprising:
a display part that displays a plurality of display screens;
a display image data storage part that stores image data for each display screen that is displayed in the display part, the display screen including an operation guidance screen with which an operation guidance is displayed for a user and an operational condition input screen with which an input instruction for an operational condition from the user is accepted;
a screen switch instruction accepting part that accepts a screen switch instruction from the user, the screen switch instruction being an instruction to switch the display screen displayed in the display part; and
a display control part that reads the image data for each display screen that is stored in the display image data storage part and displays each display screen in the display part, wherein
when a screen switch instruction to switch to the operational condition input screen is accepted by the switch instruction accepting part when the operation guidance screen is displayed in the display part, the display control part reads the image data for the operational condition input screen indicated by the screen switch instruction from the display image data storage part, and displays the operational condition input screen in the display part, as well as the operation guidance screen that has been displayed in the display part in a reduced size in a portion of a display area of the operational condition input screen.

2. The display control device according to claim 1, wherein
the operation guidance screen includes an input guidance display area that displays for the user a guidance for an input operation of the operational condition, and
the screen switch instruction accepting part accepts only the screen switch instruction to switch to the operational condition input screen in which an input of the operational condition guided in the input guidance display area in the operation guidance screen currently displayed in the display part is allowed.

3. The display control device according to claim 2, wherein
the screen switch instruction accepting part accepts the screen switch instruction to switch to the operational condition input screen in which an input of the operational condition guided in the input guidance display area by means of a touch panel function in response to a user touch to the input guidance display area is allowed.

4. The display control device according to claim 2, wherein
the screen switch instruction accepting part accepts the screen switch instruction to switch to the operational condition input screen in which an input of the operational condition guided in the input guidance display area in response to the user's pressing down of a press-down part provided independently from the input guidance display area is allowed.

5. The display control device according to claim 1, further comprising:
an operational condition storage part that stores the operational condition set in the operational condition input screen when the display control part switches the display screen of the display part from the operation guidance screen to the operational condition input screen, wherein
the screen switch instruction accepting part accepts a bidirectional screen switch instruction between the operation guidance screen and the operational condition input screen in the display part,
the display control part switches the display screen, when a screen switch instruction to switch from the operational condition input screen to the operation guidance screen is accepted by the screen switch instruction accepting part, to the operation guidance screen associated with the operational condition input screen that has been displayed in the display part, and
the operational condition storage part stores the operational condition that has been inputted in the operational condition input screen, even if the display control part switches the display screen of the display part from the operational condition input screen to the operation guidance screen.

6. The display control device according to claim 2, further comprising:
an operational condition storage part that stores the operational condition set in the operational condition input screen when the display control part switches the display screen of the display part from the operation guidance screen to the operational condition input screen, wherein
the screen switch instruction accepting part accepts a bidirectional screen switch instruction between the operation guidance screen and the operational condition input screen in the display part,
the display control part switches the display screen, when a screen switch instruction to switch from the operational condition input screen to the operation guidance screen is accepted by the screen switch instruction accepting part, to the operation guidance screen associated with the operational condition input screen that has been displayed in the display part, and
the operational condition storage part stores the operational condition that has been inputted in the operational condition input screen, even if the display control part switches the display screen of the display part from the operational condition input screen to the operation guidance screen.

7. The display control device according to claim 3, further comprising:
an operational condition storage part that stores the operational condition set in the operational condition input screen when the display control part switches the display screen of the display part from the operation guidance screen to the operational condition input screen, wherein
the screen switch instruction accepting part accepts a bidirectional screen switch instruction between the operation guidance screen and the operational condition input screen in the display part,
the display control part switches the display screen, when a screen switch instruction to switch from the operational condition input screen to the operation guidance screen is accepted by the screen switch instruction accepting part, to the operation guidance screen associated with the operational condition input screen that has been displayed in the display part, and
the operational condition storage part stores the operational condition that has been inputted in the operational condition input screen, even if the display control part switches the display screen of the display part from the operational condition input screen to the operation guidance screen.

8. The display control device according to claim 4, further comprising:
an operational condition storage part that stores the operational condition set in the operational condition input screen when the display control part switches the display screen of the display part from the operation guidance screen to the operational condition input screen, wherein
the screen switch instruction accepting part accepts a bidirectional screen switch instruction between the operation guidance screen and the operational condition input screen in the display part,
the display control part switches the display screen, when a screen switch instruction to switch from the operational condition input screen to the operation guidance screen is accepted by the screen switch instruction accepting part, to the operation guidance screen associated with the operational condition input screen that has been displayed in the display part, and
the operational condition storage part stores the operational condition that has been inputted in the operational condition input screen, even if the display control part switches the display screen of the display part from the operational condition input screen to the operation guidance screen.

9. An image forming apparatus comprising the display control device according to claim 1.

10. An image forming apparatus comprising the display control device according to claim 2.

11. An image forming apparatus comprising the display control device according to claim 3.

12. An image forming apparatus comprising the display control device according to claim 4.

13. An image forming apparatus comprising the display control device according to claim 5.

14. An image forming apparatus comprising the display control device according to claim 6.

15. An image forming apparatus comprising the display control device according to claim 7.

16. An image forming apparatus comprising the display control device according to claim 8.

17. A method for controlling a display control device, comprising:
selecting one of a plurality of guidance selection keys;
displaying a guidance selection screen selected by the guidance selection key;
selecting an operating function from the one of a plurality of guidance selection keys on the guidance selection screen;
displaying at least one of a plurality of guiding screens in accordance with the selected operating function;
switching to one of the plurality of guiding screens when at least one of a next page, previous page and screen switch keys is selected;
displaying the next page when the next page key is selected and returning to the switching step;
displaying the previous page when the previous page key is selected and returning to the switching step;
displaying an operational condition input screen when the switch key is activated, wherein displaying the operational input screen further comprises:
displaying a guidance screen associated with the operational condition;
storing the operational condition when the operational condition is inputted;
returning to displaying the operation condition input screen when the switch key is not selected;
displaying at least one of the plurality of guiding screens previously displayed before switching to the operational condition input screen and returning to the switching step when the switch key is selected;
returning to the switching step when at least one of a guidance key and reset key is not selected and when at least one of a next page, previous page and screen switch keys is not selected; and
displaying a previous guiding screen and then switching to a present guiding screen.

18. A processor-readable storage medium containing a software program operable to cause a display control device including a processor operating under the instructions of the software program to perform a method for controlling the display control device, comprising:
selecting one of a plurality of guidance selection keys;
displaying a guidance selection screen selected by the guidance selection key;
selecting an operating function from the one of a plurality of guidance selection keys on the guidance selection screen;
displaying at least one of a plurality of guiding screens in accordance with the selected operating function;
switching to one of the plurality of guiding screens when at least one of a next page, previous page and screen switch keys is selected;
displaying the next page when the next page key is selected and returning to the switching step;
displaying the previous page when the previous page key is selected and returning to the switching step;
displaying an operational condition input screen when the switch key is activated, wherein displaying the operational input screen further comprises:
displaying a guidance screen associated with the operational condition;
storing the operational condition when the operational condition is inputted;
returning to displaying the operation condition input screen when the switch key is not selected;
displaying at least one of the plurality of guiding screens previously displayed before switching to the operational condition input screen and returning to the switching step when the switch key is selected;
returning to the switching step when at least one of a guidance key and reset key is not selected and when at least one of a next page, previous page and screen switch keys is not selected; and
displaying a previous guiding screen and then switching to a present guiding screen.
